(19) United States
(12) Patent Application Publication
(10) Pub. No.: US 2023/0152006 A1
(43) Pub. Date: May 18, 2023

(54) GAS HEATER

(71) Applicant: TUTCO, LLC, Cookeville, TN (US)

(72) Inventor: Jonathan Bruce Arold, Exeter, NH (US)

(21) Appl. No.: 18/056,505

(22) Filed: Nov. 17, 2022

Related U.S. Application Data
(60) Provisional application No. 63/264,210, filed on Nov. 17, 2021.
(60) Provisional application No. 63/264,338, filed on Nov. 19, 2021.

(51) Int. Cl. F24H 3/04; F24H 9/1863; F24H 15/25; F24H 15/37

(52) U.S. Cl. CPC F24H 3/0405; F24H 9/1863; F24H 15/25; F24H 15/37; F24H 2250/02; H05B 3/12

(57) ABSTRACT

One aspect of the invention provides a gas heater including: a structure that defines a gas flow path having an upstream portion and a downstream portion; a first heating element positioned at least partially in the upstream portion of the flow path and having a first heating element maximum temperature capability; and a second heating element positioned downstream of the first heating element in the downstream portion of the flow path. The second heating element has a resistance that varies with temperature according to a second-heating-element-temperature-dependent resistivity rate.

### CROSS-REFERENCE TO RELATED APPLICATIONS

This application claims the benefit of priority to U.S. Provisional Patent Application Ser. No. 63/264,338, filed Nov. 19, 2021 and U.S. Provisional Patent Application Ser. No. 63/264,210, filed Nov. 17, 2021. The entire content of each of these applications is hereby incorporated by reference herein.

### TECHNICAL FIELD

The field relates to heaters and particularly to gas heaters having a resistive element powered by an electric current.

### BACKGROUND

Conventional gas heaters include an enclosure that houses a heating element and that defines a flow path. Electric current passes through the resistive element to cause warming of the resistive element as well as air passing along the flow path. The amount of heat generated by the resistive elements depends, among other things, on the resistance value of the resistive element.

### SUMMARY

The Applicant has appreciated that the resistance value of most heating elements varies with the temperature and that this can cause some challenges in the design and operation of high-temperature gas heaters. Resistive elements with highly temperature-dependent resistivity, such as those made of molybdenum or tungsten, may exhibit an overall low resistance at startup temperatures. Large currents may need to be passed through these materials to increase the temperature, and thus resistance value, to levels needed for higher-temperature operation. These heaters typically require higher-cost current-limiting controllers and exhibit long warm-up periods and high energy consumption to reach higher temperatures, such as those above 1000 C.

Heating element materials exist with resistivities that vary far less with temperature, such as iron-chromium-aluminum alloys.

To address these shortcomings, the Applicant has conceived of a dual-stage gas heater that includes multiple heating elements. A first heating element has a substantially constant resistivity and can be brought to an operating temperature quickly without a complex controller. A second heating element, positioned downstream (e.g., with respect to gas flow) from the first heating element, has a variable resistance and a higher temperature capability than the first heating element. During startup, heat from the first heating element increases the temperature and, thus, raises the resistance value of the second heating element before a full amount of current is provided to the second heating element. The heating elements may be arranged in serial on a common electric circuit according to some embodiments.

One aspect of the invention provides a gas heater including: a structure that defines a gas flow path having an upstream portion and a downstream portion; a first heating element positioned at least partially in the upstream portion of the flow path and having a first heating element maximum temperature capability; and a second heating element positioned downstream of the first heating element in the downstream portion of the flow path. The second heating element has a resistance that varies with temperature according to a second-heating-element-temperature-dependent resistivity rate.

This aspect of the invention can have a variety of embodiments. The first heating element can be made of a first material and the second heating element can be made of a second material, the second material having a second heating element maximum temperature capability that is higher than the first heating element maximum temperature capability. The first material can include an iron-chromium-aluminum alloy. The second material can include molybdenum. The second material can include tungsten. The first heating element maximum temperature capability can be approximately 1200 C.

Another aspect of the invention provides a method of operating a gas heater. The method includes: providing the gas heater as described herein; providing a flow of gas along the upstream portion and downstream portion of the flow path; providing electric energy to the first heating element to heat gas on the gas flow path in the upstream portion; heating the second heating element to increase the resistivity of the second heating element; and providing electric energy to the second heating element to heat gas on the flow path in excess of the first heating element temperature limit.

This aspect of the invention can have a variety of embodiments. Heating the second heating element can include heating the second heating element with gas heated by the first heating element on the gas flow path in the upstream portion. The first heating element can be constructed of a first heating element material and the second heating element can be constructed of a second heating element material. The second heating element material can be different than the first heating element material.

Providing the flow of gas includes can include providing a flow of hydrogen gas. Providing the flow of gas includes can include providing a flow of exclusively hydrogen gas. Providing the flow of gas includes can include providing a flow of exclusively hydrogen gas and nitrogen gas.

### BRIEF DESCRIPTION OF THE FIGURES

FIG. 1 is an isometric cross-sectional view of a dual-stage gas heater according to one illustrative embodiment.

FIG. 2 is a side view of dual-stage heating element of the embodiment shown in FIG. 1.

FIG. 3 is a graph of resistivity versus temperature for some alloys that may be used in a gas heater, such as the illustrative embodiment of FIG. 1.

### DETAILED DESCRIPTION

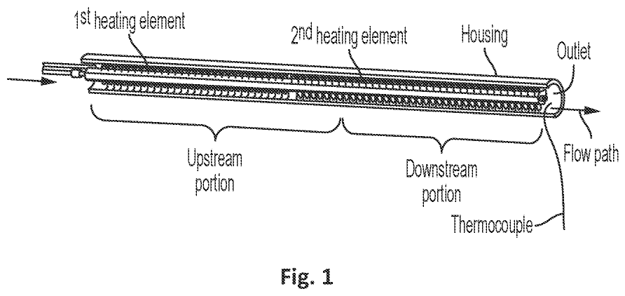

Turn now to FIG. 1 that shows a cross-sectional view of a gas heater according to one illustrative embodiment. The heater can include a cylindrical, insulative (refractory) housing that defines a flow path for gas to be heated. Two resistive heating elements can be positioned in upstream and downstream portions of the housing, respectively. A first thermocouple can be positioned between the first and second heating elements and a second thermocouple can be positioned downstream of the second heating element near an outlet of the housing. A controller (not shown) can be programmed to control the flow of current to the first and second heating elements based on a desired temperature set point and temperature readings that are taken at one or both of the thermocouples. Suitable thermocouples (e.g., Type K or Type S, platinum, tungsten, radium) can be selected based on the anticipated temperatures.

The housing can define a flow path for gas to be heated and at least partially encloses the heating elements to help direct heat to the gas. In the illustrative embodiment of FIG. 1, the housing has a cylindrical shape and is constructed of a ceramic material. It is to be appreciated that other geometries and materials are also possible. According to some alternate embodiments, the housing includes a reflective (e.g., thermal-reflective, infrared-reflective, and the like) interior surface to help direct heat onto gas flowing along the flow path.

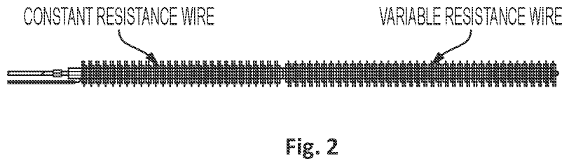

The heating element shown in FIGS. 1 and 2 includes a central mandrel that provides a supportive structure for resistive wire of the heating elements and that is shaped and sized to fit internally to the housing. The central mandrel can be formed from a high-temperature dielectric such as a ceramic. The resistive wires, as shown, are wound about the mandrel in a manner that positions the wire within the flow path of gas to optimize heat transfer. The mandrel can include a hollow core to receive lead wires of the heating elements and/or the thermocouples. The central mandrel advantageously provides mechanical support to the resistive wire of the heating elements, which may expand and/or relax when heated, thereby causing a short circuit if thermally deformed adjacent winds contact each other. In some embodiments, the mandrel includes helical flutes or threads to receive the wires of the heating elements.

The heating elements can be arranged serially in an electrical circuit along with a controller and a lead that passes through an interior of the mandrel. The first heating element, positioned in an upstream portion of the housing, can be constructed of a resistive wire that has a substantially constant resistivity with respect to temperature. According to some embodiments, the resistive wire of the first element is made of a ferritic iron-chromium-aluminum alloy, such as KANTHAL® that may be sourced from Kanthal Heating Technology of Amherst, N.Y. In another embodiment, the resistive wire can be nickel-chromium. In one embodiment, a wire can be considered to have substantially constant resistivity with respect to temperature if the resistance varies less than 5% (e.g., about 4% or about 3%) between room temperature (e.g., 20 C) and the operating temperature of the first heating element.

In some embodiments, the first heating element includes two sub-stages of the same material, but having two different gauges. For example, the first sub-stage can have a finer gauge that has a higher resistance than a downstream sub-stage having a coarser gauge.

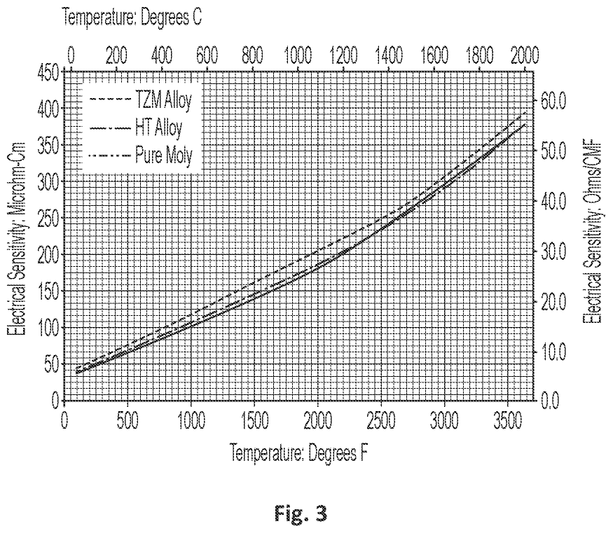

The second heating element can be constructed of a refractory resistive wire having a resistivity that increases with temperature, such as tungsten, molybdenum, tantalum, alloys thereof, and the like. In some embodiments, the second heating element is formed from a ceramic-like wire alternative such as molybdenum disilicide and the like. FIG. 3 shows resistivity versus temperature curves for materials that may be utilized in the second heating element, according to some illustrative embodiments. The material of the second heating element is also capable of operating at high temperatures, including temperatures up to and exceeding 1500 C. This is in contrast to most constant-resistance heating elements, such as ferritic iron-chromium-aluminum alloy, that have maximum operating temperatures around 1200 C.

The gauges of both the first and the second heating element can be optimized to accommodate various electrical voltages. Further, the heating elements can be solid or stranded.

The heating elements can be wound about the central mandrel in a manner calculated to increase or maximize thermal density, mass, and/or surface area of the heating elements exposed to the gas contained in the housing. For example, the wire of the heating elements can be wound substantially helically with respective to the central mandrel. The heating elements can also have serpentine loops along the helical path that radiate inward and outward with respect to a central axis. The serpentine loops can arranged in an axially helically pattern.

In some embodiments, an axial gap is formed between the resistive heating elements, which can prevent or limit upstream migration of heat from the second heating element that could damage the first heating element. In some cases, the gas flow may also limit upstream migration of thermal dispersion to the first heating element.

Adjacent heating elements (e.g., first and second elements) can be joined by welding, e.g., TIG welding (with or without a filler material), percussive welding, and the like.

Multiple heaters (e.g., 16) can be used in parallel to heat a desired volume of gas.

### Control

Temperature measurement sensors may be positioned at various points of the gas heater to measure operating temperatures. Measured temperatures may be used by the controller or merely for reference. Infrared sensors may also be used, particularly for temperatures that exceed 1200 C, such as wire temperatures of the heating elements or the gas at the outlet of the heater.

The principles of how to use feedback (e.g., from a temperature sensor such as thermocouple, a thermistor, infrared and the like) in order to modulate operation of a component are described, for example, in Karl Johan Astrom & Richard M. Murray, Feedback Systems: An Introduction for Scientists & Engineers (2008) and can be implemented using a Proportional-Integral-Derivative (PID) controller and the like.

In some embodiments, a temperature sensor such as an infrared imaging device can be utilized to protect the heater against operation at temperatures over specification that may damage the heater (e.g., the first resistive heater(s)). Such a condition may be caused by an interruption of flow of the gas to be heated, which acts as a heat sink relative to the resistive-heating elements. Such an over-heat-prevention system is described in U.S. Pat. No. 10,736,180.

In some embodiments, a current detector can be coupled to a portion of the second heating element. The current detector can identify the amount of current reaching that particular coupling point to the second heating element. Based on the dimensions (length, volume, and the like) of the second heating element and the detected current (and the current inputted into the system), the current detector can determine the resistivity of the second heating element at a given time. This may be advantageous, particularly as an indirect measurement of temperature of the system, and/or for detecting operating errors of the system.

The control system can be a computing device such as a microcontroller (e.g., available under the ARDUINO® or IOIO™ trademarks), general-purpose computer (e.g., a personal computer or PC), workstation, mainframe computer system, and so forth. The control system (“control unit”) can include a processor device (e.g., a central processing unit or “CPU”), a memory device, a storage device, a user interface, a system bus, and a communication interface.

### Mechanism of Action

In operation, a flow of gas to be heated is first passed along the flow path of the enclosure. Electric current is passed through the first resistive heating element to heat the gas that passes therethrough. The heated gas, in turn, heats the second heating element thereby causing the variable resistance value of the second heating element to increase. Heat is also generated by second heating element, once its temperature and resistivity have increased to a point that enables the production of thermal energy.

### Optional Independent Control of Heating Elements

Although embodiments of the invention leverage the substantially constant resistance of the first heating element to prevent current inrush to the variably resistive second heating element, embodiments of the invention could wire the different types of resistive heating elements on separate circuits. In such an embodiment, a controller could monitor a temperature within the heater and delay actuation of the variably resistive heating element until the variably resistive heating element reaches a desired temperature at which a desired resistance is provided. Similarly, if a fault is detected that causes the temperature of the variably resistive heating element to drop, the controller can be programmed to immediately suspend current to at least the variably resistive heating element.

### Optional Non-Resistive Heating of Variably Resistive Heating Element

Although embodiments of the invention leverage the substantially constant resistance of the first heating element to prevent inrush to the variably resistive second heating element, embodiments of the invention could omit the first heating element and utilize a different heating source (e.g., combustion) to heat a variably resistive heating element to a sufficient temperature to achieve the desired resistance before current is applied.

1. A gas heater comprising:
a structure that defines a gas flow path having an upstream portion and a downstream portion;
a first heating element positioned at least partially in the upstream portion of the flow path and having a first heating element maximum temperature capability; and
a second heating element positioned downstream of the first heating element in the downstream portion of the flow path, the second heating element having a resistance that varies with temperature according to a second-heating-element-temperature-dependent resistivity rate.

2. The gas heater of claim 1, wherein the first heating element is made of a first material and the second heating element is made of a second material, the second material having a second heating element maximum temperature capability that is higher than the first heating element maximum temperature capability.

3. The gas heater of claim 2, wherein the first material includes an iron-chromium-aluminum alloy.

4. The gas heater of claim 3, wherein the second material includes molybdenum.

5. The gas heater of claim 3, wherein the second material includes tungsten.

6. The gas heater of claim 3, wherein the first heating element maximum temperature capability is approximately 1200 C.

7. A method of operating a gas heater, comprising:
providing the gas heater according claim 1;
providing a flow of gas along the upstream portion and downstream portion of the flow path;
providing electric energy to the first heating element to heat gas on the gas flow path in the upstream portion;
heating the second heating element to increase the resistivity of the second heating element; and
providing electric energy to the second heating element to heat gas on the flow path in excess of the first heating element temperature limit.

8. The method of claim 7, where heating the second heating element comprises heating the second heating element with gas heated by the first heating element on the gas flow path in the upstream portion.

9. The method of claim 8, wherein the first heating element is constructed of a first heating element material and the second heating element is constructed of a second heating element material, the second heating element material being different than the first heating element material.

10. The method of claim 7, wherein providing the flow of gas includes providing a flow of hydrogen gas.

11. The method of claim 7, wherein providing the flow of gas includes providing a flow of exclusively hydrogen gas.

12. The method of claim 7, wherein providing the flow of gas includes providing a flow of exclusively hydrogen gas and nitrogen gas.
